(19) United States
(12) Patent Application Publication
(10) Pub. No.: US 2009/0311037 A1
(43) Pub. Date: Dec. 17, 2009

(54) INSERT FOR DETACHABLE COUPLING TO BINDERS

(76) Inventor: Chi Lam Leung, Singapore (SG)

Correspondence Address: OSTROLENK FABER GERB & SOFFEN, 1180 AVENUE OF THE AMERICAS, NEW YORK, NY, 100368403, US

(21) Appl. No.: 11/915,857

(22) PCT Filed: Apr. 28, 2006
(86) PCT No.: PCT/SG06/00108

§ 371 Date: Nov. 29, 2007

(30) Foreign Application Priority Data
Apr. 29, 2005 (SG) 200502826-1

(51) Int. Cl. B42F 13/00; B42D 5/00

(52) U.S. Cl. 402/79; 281/38

(57) ABSTRACT

An insert is provided for detachable coupling to a plurality of spaces binding guides holding a stack of sheet material. The insert comprises a flexible body and a hook comprising a finger portion extending substantially parallel to a side of the flexible body to form an elongates slit with the flexible body. The finger portion extends from near an end portion of the side of the flexible body in a direction away from said end portion such that the opening of the elongates slit faces away from said end portion. The elongated slit is configured for slidably receiving a binding guide through an opening of the elongated slit whereby to engage the binding guide in a position along the elongated slit. A second hook binding guide to couple the insert to the binding guides.

### FIELD OF THE INVENTION

The invention relates to an insert for a stack of sheet material which is bound together with a binder, such as in a notebook or personal organizer. In particular, the invention relates to an insert that can be detachably coupled to the binder for marking a page of the stack, or for other uses.

### BACKGROUND AND PRIOR ART

Notebooks or personal organizers are commonly used for the recording of various kinds of information. These include, amongst other things, calendar planners, personal diaries, names and addresses of contacts, notes and task lists. They typically comprise pre-printed sheets of paper for writing the information, tab dividers, pockets, pouches or other features. These pre-printed sheets of paper may include ruled lines, calendars, spaces for names and addresses according to the design of the manufacturer. For versatility, personal organizers often include open-and-close ring binders to conveniently bind or detach sheets of material. For notebooks, the stack of sheet material is sometimes permanently bound together by a binding coil, such that the relative locations of the material are permanently fixed. These rings and coils are examples of binding guides that guide each sheet of material when it is flipped over while allowing the materials to retain their relative positions in the stack. For open-and-close ring binders, these sheets can be removed by opening the rings, whereas for binding coils, the sheets should usually be torn from the binding coil for removal.

In order to provide greater flexibility, dividers and other components for these personal organizers and notebooks which are meant to be detachably used should preferably have features that allow them to be conveniently attached to or removed from the binder. This allows customization because the various components can then be releasably coupled to the binder in any location within the stack of material and are reusable by moving them to another location.

There are various examples of these removable components in the prior art. U.S. Pat. No. 6,086,281 entitled “Page Finder Apparatus and Method” discloses a page finder that includes circular notches along its left side for removably attaching it to the binder rings of a notebook. Thus, the page finder may be selectively moved within the notebook to provide a user with ready access to the insert information adjacent to a current time page as the user plans records and reviews periodic activities.

In another example, U.S. Pat. No. 5,876,144 entitled “Organizer Assembly for Removable Attachment to a Ringed Notebook or Ringed Binder” describes a detachable component in the form of an organizer assembly having a portion with a plurality of spaced openings therethrough that are arranged and sized so as to accommodate the rings of a ringer notebook or ringed binder. The assembly also has a mating portion for releasably attaching a selected item having a corresponding mating edge to secure it to the assembly.

A major disadvantage of the aforesaid prior art inserts is that they use apertures along the sides of the inserts for coupling to the binders. Each aperture receives and engages one binding guide, and the apertures must be configured to correspond to a fixed arrangement of binding guides. They must be correctly arranged, sized and shaped to properly couple the inserts to the binding guides. If the apertures in the inserts do not correspond to the positions of the binding guides, they cannot be used. This approach is inflexible because different personal organizers or notebooks may have different arrangements of binding guides that are at different positions or have different separation distances. Accordingly, an insert that is usable for one design or arrangement of binding guides may not be usable for another design or arrangement. The onus is on the user to find an insert that corresponds exactly to the binder design.

### SUMMARY OF THE INVENTION

It is therefore an object of the invention to provide an insert that can be conveniently used with and coupled to and removed from binding guides having a range of arrangements and separation pitches.

Accordingly, the invention provides an insert for detachable coupling to a plurality of spaced binding guides holding a stack of sheet material, comprising: a flexible body; and a hook comprising a finger portion extending substantially parallel to a side of the flexible body to form an elongated slit with the flexible body that is configured for slidably receiving a binding guide through an opening of the elongated slit whereby to engage the binding guide in a position along the elongated slit; wherein the finger portion extends from near an end portion of the flexible body in a direction away from said end portion such that the opening of the elongated slit faces away from said end portion.

Other objects and advantages of the present invention will be apparent from the following description and the accompanying drawings.

### BRIEF DESCRIPTION OF THE DRAWINGS

An example of an insert in accordance with the invention will now be described with reference to the accompanying drawings, in which:

FIG. 1 is a front view of an insert according to the preferred embodiment of the invention which is arranged in a first orientation for coupling to a ring-shaped binder binding a stack of paper; and

FIG. 2 is a front view of the insert which is arranged in a second orientation for coupling to a binder comprising a binding coil.

### DETAILED DESCRIPTION OF THE PREFERRED EMBODIMENT OF THE INVENTION

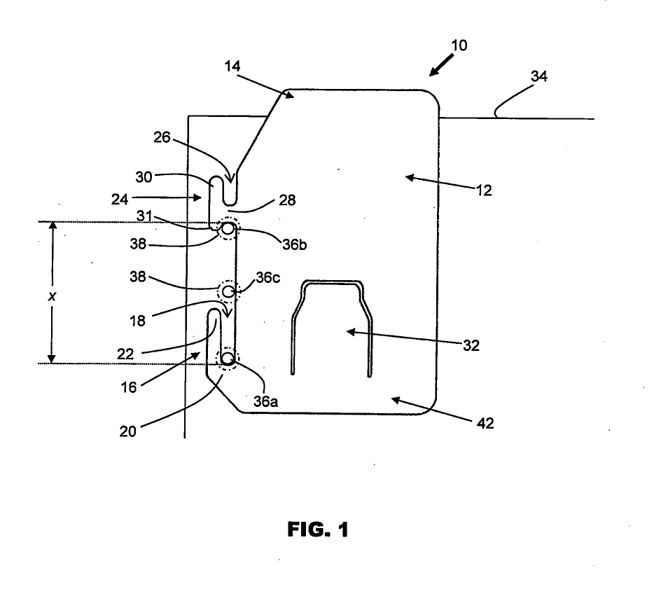

As shown in FIG. 1, the insert according to the preferred embodiment of the present invention, generally designated 10, is in the form of a tab divider that is shaped to be conveniently locatable when it is positioned in a stack of bound material. The insert 10 comprises a flexible body 12 having a first tab portion 14, a first hook 16 and a second hook 24. The first hook 16 has a stem portion 20 and a finger portion 22 to form a first elongated slit 18 with the flexible body 12 that is configured for slidably receiving a first binding guide through an opening of the slit 18 whereby to engage the binding guide in a position along the slit 18.

The first tab portion 14 is comprised in an end portion of the flexible body 12. The finger portion 22 extends substantially parallel to a side of the flexible body 12 from near the end portion of the flexible body 12 in a direction away from the said end portion such that the opening of the first elongated slit 18 faces away from said end portion.

Since the stem portion 20 is integrated with the flexible body 12 in this embodiment, the finger portion 22 appears to extend directly from the flexible body 12. The first elongated slit 18 is thus bounded on three sides by the finger portion 22 and the flexible body 12 incorporating the stem portion 20 respectively. Alternatively, the stem portion 20 may protrude out of the flexible body 12 so that the finger portion 22 extends from the protruding stem portion 20 instead, as in the case of the second hook 24.

The second hook 24 has a protruding stem portion 28 and a second finger portion 30 that extends substantially parallel to the side of the flexible body 12 to form a second elongated slit 26 with the flexible body 12. The second elongated slit 26 is configured so that it may also slidably receive a second binding guide through an opening of the slit 26 whereby to engage the second binding guide in a position along the slit 26. Thus, the second elongated slit 26 is bounded on three sides by the stem portion 28, second finger portion 30 and flexible body 12 respectively.

In the preferred embodiment, the opening of the second elongated slit 26 faces the same direction as the opening of the first elongated slit 18, that is, it faces away from the opening of the first elongated slit 18. It should. be appreciated that the same function can be achieved if the two openings face different direction, for example, if the openings of the first and second elongated slits 18, 26 face each other. The tab portion 14 at the end portion of the flexible body 12 is preferably shaped to protrude from a side of the stack of material in use to facilitate locating the insert 10 placed in the stack of material.

Additionally, for a better fit with a set of binding rings which has a known separation distance, the second hook 24 of the insert 10 preferably includes a flange portion 31 extending from the stem portion 28 in the direction of the first hook 16 to engage a binding guide 36 that is arranged to contact the stem portion opposite the second elongated slit 26 when a first binding guide is engaged within the first elongated slit 18. A set of binding guides or rings refers to a group of usually two or three binding guides that are grouped together. In FIG. 1, a set of binding guides comprising three binding rings 36a-c is shown. The binder may altogether comprise two or three sets of binding rings that are spaced apart from one another.

Preferably, a distance x between an innermost point of the first elongated slit 18 to the an innermost point of the flange portion 31 facing the opening of the first slit 18 is substantially equal to the distance between the outermost points of the set of binding guides engaged by the first and second hooks 16, 24. Most preferably, this distance x is substantially equal to 41.5 mm.

The stem portion 28 of the second hook 24 projects from the flexible body 12 substantially perpendicularly from a side of the flexible body 12 in the plane of the flexible body 12 and the second finger portion 30 projects from the stem portion 28 substantially parallel to the side of the flexible body 12. The finger portions 22, 30 of the first and second hooks 16, 24 respectively point or extend towards substantially the same direction in the preferred embodiment. The advantage of doing so will be apparent from the description of its use below.

The insert 10 is preferably made from plastic material, but cardboard, polypropylene, polyvinyl chloride (PVC) or other materials that are sufficiently flexible and durable may be used. For convenience in manufacture, the insert 10 may be cut out from a single sheet of any of the aforesaid materials into the required shape. The flexible body 12 may also have an attachment portion, such as a clip-like flap 32, which is pliable to allow loose pieces of paper or other items to be attached to the flap 32 between the flap 32 and the flexible body 12.

In FIG. 1, the insert 10 is placed on top of a sheet of paper 34 in a stack and engaged to a pair of binding guides in the form of ring guides 36 comprised in the binder. The ring guides 36 are shown in cross-section to illustrate how they are engaged by the first and second hooks 16, 24 of the insert 10. As is usually the case, the paper 34 has punched holes 38, and each punched hole is shaped and located to allow the binding guide to pass through the hole 38. Each punched hole 38 of the papers 34 in the stack can slide along each binding guide while the pages are being turned.

To engage the insert to the binding guides 36, the first hook 16 is first positioned over a first binding guide 36a, which is preferably the bottom-most ring of a set of three rings 36a-c of the binder. The first binding guide 36a is then slotted into the first elongated slit 18. Thereafter, the second hook 24 is positioned over a second binding guide 36b. The second binding guide 36b should be located inside the flange portion 31 of the second hook 24 by flexing the flexible body 12 and flange portion 31 over the second binding guide 36b to engage the same. The flexible body 12 is then unflexed, and the result will be that one binding guide 36a is received by the first elongated slit 18 of the first hook 16 and another binding guide 36b is received by the flange portion 31 of the second hook 26. As can be seen from FIG. 1, the insert 10 is prevented from being separated from the binding guides 36 by the finger portion 22 of the first hook 16 and the flange portion 31 of the second hook 24.

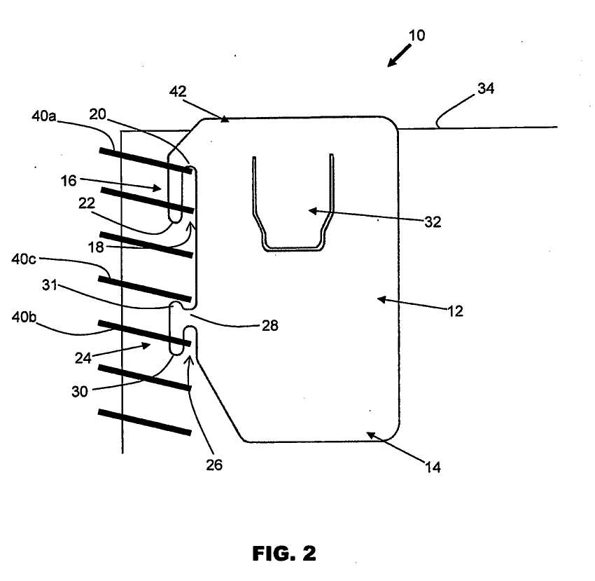

FIG. 2 is a front view of the insert 10 coupled to a binder comprising a binding coil 40 shaped into circular loops. Each loop may be referred to as a binding guide. As compared to the orientation in FIG. 1, the insert 10 is flipped over along a horizontal axis so that the binding guides 40 are engaged primarily by the first and second elongated slits 18, 26. Therefore, the first hook 16 is first positioned over a first binding guide 40a of the binding coil, which is preferably the top-most loop of the binding coil 40. The first binding guide 40a is then slotted into the first elongated slit 18. Thereafter, the second hook 24 is positioned over a second binding guide 40b to locate the binding guide 40b inside the second elongated slit 26 of the second hook 24 by flexing the flexible body 12. The flexible body 12 is flexed sufficiently so that the second binding guide 40b is positioned at the mouth of the second elongated slit 26 for slotting into the same. The flexible body 12 is then unflexed, and the result will be that one binding guide 40a is received by the first elongated slit 18 of the first hook 16 and another binding guide 40b is received by the second elongated slit 26 of the second hook 24. As can be seen from FIG. 2, the insert 10 is engaged to the binding guides 40a, 40b by the finger portions 22, 30 of the first and second hooks 16, 24.

To cater to different pitches between binding guides 36 of different binders, it is preferable that one of the elongated slits, in this case the first elongated slit 18 of the first hook 16, is made longer than the second elongated slit 26. Whereas one of the binding guides 40a is contacted by the flexible body 12, stem portion 20 and first finger portion 22 in the first elongated slit 18 of the first hook 16, the other binding guide 40b may be bounded only by the flexible body 12 and the second finger portion 30 in any position along the second elongated slit 26. In this way, at least two binding guides 40 may be engaged inside the slits 18, 26 regardless of the pitches of the binding guides 40 as long as they can be positioned within the bounds of the first and second elongated slits 18, 26 defined by the lengths of the respective finger portions 22, 30. The approach solves the problem faced in the prior art where a particular insert is only compatible with binders having binding guides separated by a single fixed separation distance. Accordingly, using the insert 10 according to the preferred embodiment, the exact distance between the first and second binding guides 40a, 40b does not matter as long as they fall within the ranges of the first and second elongated slits 18, 26 respectively.

A second tab portion 42 of the flexible body 12 is preferably shaped to protrude from a side of the stack of paper 34 to facilitate locating the insert 10 in the stack when the insert 10 has been flipped over. The second tab portion 42 is on a side of the flexible body 12 that is opposite to the end portion comprising the first tab portion 14.

In addition, since the second hook 24 has a flange portion 31 projecting from the stem portion 28, the binding guides can be engaged more securely by the flange portion 31 abutting or engaging another binding guide 40c adjacent to the second binding guide 40b. This also helps to prevent the binding guides 40a, 40b from sliding out of the first and second elongated slits 18, 26 when the stack of papers 34 is turned over. The width of the stem portion 28 is smaller than a space between adjacent binding guides 40b, 40c on either side of the stem portion 28 so that it is insertable between the adjacent binding guides.

Having described the invention in detail and by reference to the preferred embodiment, it will be apparent that modifications and variations thereof are possible without departing from the scope of the invention. For example, although the preferred embodiment of the invention is described in relation to its use to engage binding guides in the form of ring binders or binding coils, it would be appreciated that it is also applicable to other forms of binding guides.

1. An insert for detachable coupling to a plurality of spaced binding guides holding a stack of sheet material, comprising:
a flexible body; and
a hook comprising a finger portion extending substantially parallel to a side of the flexible body to form an elongated slit with the flexible body that is configured for slidably receiving a binding guide through an opening of the elongated slit whereby to engage the binding guide in a position along the elongated slit;
wherein the finger portion extends from near an end portion of the side of the flexible body in a direction away from said end portion such that the opening of the elongated slit faces away from said end portion.

2. The insert as claimed in claim 1, including a second hook comprising a second finger portion extending substantially parallel to said side of the flexible body to form a second elongated slit with the flexible body that is configured for slidably receiving a second binding guide through an opening of the second elongated slit whereby to engage the second binding guide in a position along the second elongated slit.

3. The insert as claimed in claim 2, wherein the opening of the second elongated slit faces away from the opening of the first elongated slit.

4. The insert as claimed in claim 2, wherein the second hook further comprises a stem portion projecting from the flexible body in the plane of the flexible body and the second finger portion extends from said stem portion.

5. The insert as claimed in claim 4, wherein the second elongated slit is bounded on three sides by the stem portion, second finger portion and the flexible body respectively.

6. The insert as claimed in claim 4, wherein a width of the stem portion is smaller than a space between adjacent binding guides on either side of the stem portion such that the stem portion is insertable between the adjacent binding guides.

7. The insert as claimed in claim 2, including a flange portion projecting from the second hook in the direction of the first hook for engaging another binding guide when the first binding guide is engaged in the first elongated slit.

8. The insert as claimed in claim 7, wherein a distance between an innermost point of the first elongated slit and an innermost point on the flange portion facing the opening of the first elongated slit is substantially equal to a distance between outermost points of a set of binding guides engaged by the first and second hooks.

9. The insert as claimed in claim 8, wherein the said distance is substantially equal to 41.5 mm.

10. The insert as claimed in claim 1, wherein the first finger portion extends directly from the flexible body.

11. The insert as claimed in claim 10, wherein the first elongated slit is bounded on three sides by the first finger portion and the flexible body.

12. The insert as claimed in claim 1, wherein the flexible body further comprises an attachment portion cut from the flexible body that is pliable for receiving and attaching objects between the attachment portion and the flexible body.

13. The insert as claimed in claim 1, wherein the insert is cut out from a single sheet of flexible material into a required shape.

14. The insert as claimed in claim 13, wherein the flexible material is selected from the group consisting of: plastic, cardboard, polyvinyl chloride and polypropylene material.

15. The insert as claimed in claim 1, wherein the end portion further comprises a tab portion that is shaped to protrude from a side of the stack of material when the insert is engaging the binding guides.

16. The insert as claimed in claim 15, including a second tab portion on a side of the flexible body that is opposite to the end portion, the second tab portion being shaped to protrude from a side of the stack of material when the insert is engaging the binding guides.

17. The insert as claimed in claim 1, wherein the first hook is configured to engage an outermost binding guide of a set of binding guides holding the stack of material.

18. The insert as claimed in claim 1, wherein a length of the first elongated slit is longer than a length of the second elongated slit.

19. The insert as claimed in claim 1, wherein the hook is configured to engage a binding guide in the shape of a ring binder.

20. The insert as claimed in claim 1, wherein the hook is configured to engage a binding guide in the shape of a loop of a binding coil.
